(19) United States
(12) Patent Application Publication
(10) Pub. No.: US 2003/0192209 A1
(43) Pub. Date: Oct. 16, 2003

(54) Electroluminescent lamp-based greeting cards

(76) Inventor: Ming-Yuan Yeh, San Jose, CA (US)

Correspondence Address: MING-YUAN YEH, APT. 814, 373 RIVER OAKS CIRCLE, SAN JOSE, CA, 95134, US

(21) Appl. No.: 10/121,653

(22) Filed: Apr. 15, 2002

(51) Int. Cl. G09F 1/00; G09F 13/22

(52) U.S. Cl. 40/124.02; 40/544

(57) ABSTRACT

An illuminated card device formed from sheet stock, for use as a greeting card or the like. One or more EL lamps are attached either flat against the card or mounted as pop-up elements. Two wires lead out from the EL lamps to a high voltage driver circuitry that converts a low voltage signal into an AC high voltage signal (approximately 40V to 300V peak to peak.) This circuitry is mounted on a PCB, hidden from view. A sliding tab in the shape of a ‘t’ slides through two slits in the card. Metal elements are mounted to the tab and between the two slits. When the card is opened, the two metal elements make contact, creating an electrical short to allow the battery to supply current to the high voltage conversion circuit. The high voltage driver circuit provides signals to illuminate the EL lamps.

### FIELD OF THE INVENTION

This invention relates to the field of greeting cards and displays made of folded sheet stock. More particularly, the invention relates to illuminated greeting cards and displays for advertising or similar purposes and for novelty items.

### BACKGROUND OF THE INVENTION

This invention relates to illuminated greeting cards. BACKGROUND—DESCRIPTION OF PRIOR ART

Consumers have always been looking for an escape from the traditional two-dimensional greeting card with printed artwork and greeting inside, especially when the card is given to a close friend, wife or husband. Musical cards and pop-up cards helped to satisfy some of the demand. In the meantime, lighting methods developed using LEDS, lamps and miniature light bulbs were used to farther enhance the cards. Although illuminated greeting cards and lit displays have been proposed, they have not experienced commercial success and suffered from a number of disadvantages.

(a) First, the illumination devices (LEDS, lamps, and miniature light bulbs) are often too large, hard, thick or bulky to be incorporated into a thin flexible greeting card. To provide sufficient lighting, many LEDS or lamps had to be used, causing the card to gain considerable size and weight, making the card not unsuitable for mailing.

(b) Also, the cost of the electrical components is prohibitive towards manufacturability. The high number of LEDS or lamps is a large part of the total costs.

(c) The results of lighting schemes such as LEDS are not visually pleasing; LEDS provide point sources of light rather than a uniform light source (i.e.: the lighted EL display on a cellular phone.)

(d) Lighting schemes such as LEDS and lamps cannot be seamlessly incorporated into pop-up cards because of their size and bulk. Pop-up cards need many thin elements that can collapse together when the card is closed. However, LEDS and lamps occupy a lot of thickness, making it difficult to incorporate. As an example, U.S. Pat. No. 4,363,081 issued Dec. 7, 1982 to Robert Wilbur showed a LED-driven greeting card. However, the LEDs were attached onto a stiff printed circuit board, and the LEDs themselves were cylindrical and bulgy in shape.

(e) LEDS and lamps are hard, stiff devices that do not blend in well with a greeting card which is generally comprised of flexible materials.

(f) Such illumination schemes such as LEDS and miniature light bulbs can easily be destroyed if dropped or accidentally stepped on.

Objects and Advantages

Accordingly, besides the objects and advantages of the thin EL-based greeting card described in my above patent, several objects and advantages of the present invention are:

(a) to provide a thin, light-weight illuminated greeting card;

(b) to provide an inexpensive, low-component count illuminated greeting card;

(c) to provide an illuminated greeting card with uniform lighting on the illuminated surface;

(d) to provide an illuminated greeting card that can incorporate pop-up features or 3D features with illumination;

(e) to provide a flexible illuminated greeting card;

(f) to provide a rugged illuminated greeting card;

Accordingly, it is the object of the present invention to provide an illuminated greeting card, novelty item, gift package, advertising display, or the like, which is flexible, ultra-thin, durable, uniformly lit, and suitable for 3-D cards or pop-up cards.

It is a further object of the invention to provide an illuminated device that can be automatically switched on or off depending on whether the card is opened or closed.

Another important object of the invention is to provide an illumination element that can be attached to the front, the back, or the inside of the card, or that can be used as a pop-out element of a greeting card.

Other objects and features of the present invention will become apparent from the following description, which should be read in connection with the accompanying drawings. It is to be understood, however, that this description and the drawings are intended for the purpose of illustration only and not as a definition of the limits or scope of the invention. The scope of the invention is intended to be limited only as set forth in the claims appended at the end of the description.

### SUMMARY

In accordance with the present invention an illuminated greeting card comprises a folded card formed from sheet stock or plastic, a power supply such as a button cell battery, an EL display or EL lamp, a high voltage driver circuit to illuminate to the EL lamp, and a switch for turning on or off the EL lamp.

### DRAWINGS

Drawing Figures

In the drawings, closely related figures use the same number but different suffixes.

FIGS. 1A and 1B show an illuminated greeting card with two EL lamps connected in parallel, switched on or off by a sliding contact switch.

FIG. 2 shows an elevational front view of a typical EL driver circuit based off Supertex's™ HV825 chip.

FIG. 3 shows an elevational front view of a typical EL driver circuit based off Durel's™ D340B chip.

FIG. 4 shows an elevational back view of a typical EL driver circuit based off Supertex's HV825™ chip.

FIG. 5 shows an elevational back view of a typical EL driver circuit based off Durel's D340™ chip.

FIG. 6 shows a front perspective view of an EL illuminated greeting card in a semi-closed position with the contact switch mounted on the back of the card.

FIG. 7 shows a front view of an EL illuminated greeting card in an open position with the contact switch mounted on the back of the card.

FIG. 8 shows a perspective view of a pop-up EL illuminated greeting card with the EL lamp acting as a pop-up element.

Reference Numerals in Drawings

| | |
|---|---|
| 10 square EL lamp | 70 first fold of card |
| 11 heart-shaped EL lamp | 71 second fold of card |
| 12 greeting card | 72 middle fold of card |
| 14 sliding switch | 73 inside front cover |
| 20 EL driver chip | 74 inside back cover |
| 21 inductor | 75 outside front cover |
| 22 first resistor | 76 outside back cover |
| 23 second resistor | 77 front cover |
| 24 high voltage diode | 78 back cover |
| 25 high voltage capacitor | 80 first slit in card for EL lamp |
| 30 trace for v+ terminal of battery | 81 second slit in card for EL |
| | lamp |
| 31 trace for v− terminal of battery | 82 paper pop-up element |
| 32 EL driver output 1 | 83 EL lamp pop-up element |
| 33 EL driver output 2 | 84 folded rectangular paper |
| 40 printed circuit board (PCB) | 85 vertical fold in square paper |
| 41 flex circuit board | 86 triangular fold in square |
| | paper |
| 42 PCB type circuit | 87 extended attachment to |
| | triangular fold |
| 50 attachment | 88 attachment to 3-D element |
| 51 hinge | 89 middle fold of triangular fold |
| 52 tab | 90 via for positive (v+) battery |
| | connection |
| 53 first slit in paper | 91 via for negative (v−) battery |
| | connection |
| 54 second slit in paper | 92 negative (v−) connection to |
| | battery |
| 55 first metal element | 93 positive (v+) connection to |
| | battery |
| 56 second metal element | 100 battery |
| 57 metal element aligned with edge | 101 EL driver chip |
| 58 metal element protruding from edge | 103 first slanted fold of |
| | triangular fold |
| 59 T-shaped head of tab | 104 second slanted fold of |
| | triangular fold |
| | 105 hinge |

### DETAILED DESCRIPTION

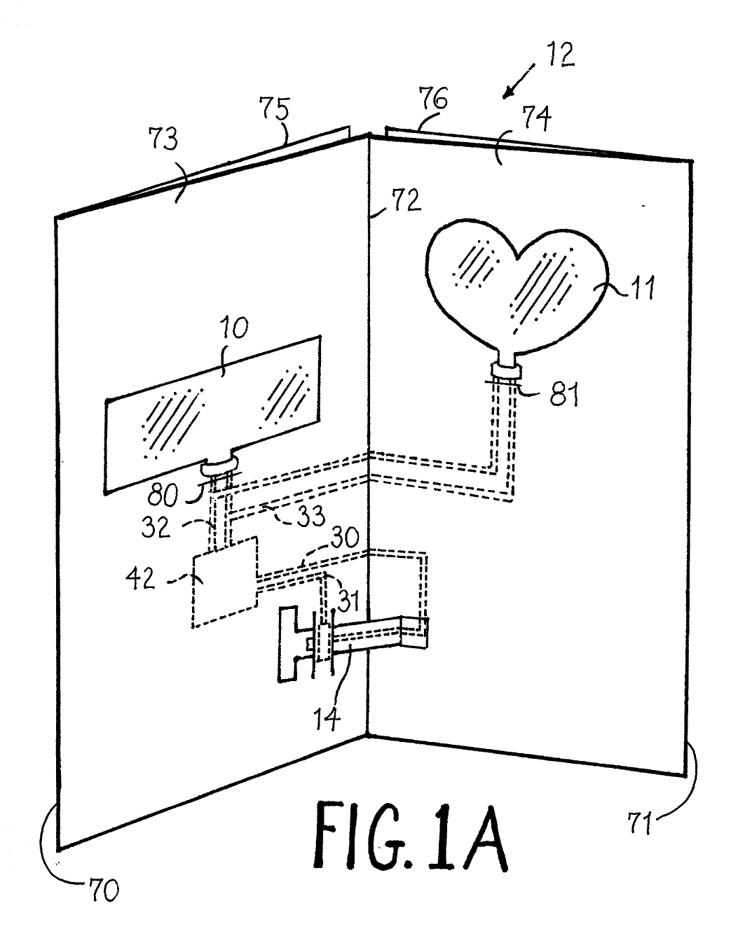

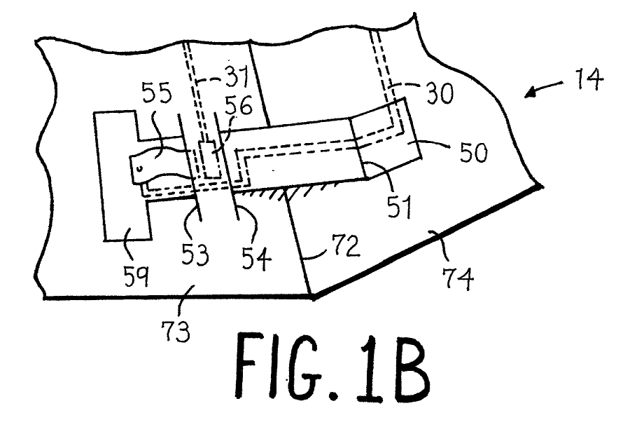

Description—FIGS. 1A and 1B—Preferred Embodiment

A preferred embodiment of the invention in the form of a greeting card 12 is shown in FIG. 1. Here, the card is shown in its open position from an inside perspective view. The front cover comprises a front cover section 75 and an inner front cover section 73 hinged about a fold 70. The back cover comprises a back cover section 76 and an inside back cover section 74 hinged about a fold 71. The inside front cover section 73 and inside back cover section 74 are hinged about a middle fold 72 which is directed in the opposite direction as the other two folds 70 and 71.

An EL lamp 10 is attached to the inside front cover section 73 by an adhesive such as double-sided sticky tape. On the inside back cover 74, another EL lamp 11 is attached to the card. A printed circuit board (PCB) or some form of printed conductive tracing 42 is attached to the back of the inside front cover so that it is hidden from view. A flexible PCB is preferred as it would allow the card to be as thin as possible. This PCB contains the high voltage driver circuitry needed to drive the EL lamps. From this PCB, two wires 32 and 33 stream out and route to the two EL lamps. The wires may be attached to the card by tape, glue or some other form of adhesive substance. Two slits in the card 80 and 81 allow the wires to surface and attach to the two terminals of the EL lamps. If so desired, the EL lamp could be directly glued and connected to the PCB without occupying much space and eliminating the wires.

Two additional wires 30 and 31 route from the PCB and connect to two metal elements 55 and 56 to form a sliding switch 14. FIG. 1A shows an enlarged view of the sliding switch 14. The inner front cover of the card has two slits 53 and 54 that allow a T-shaped tab 52 to pass through. The T-shaped head 59 of this tab will not fit through the two slits and will determine how wide the card can open. The long skinny end of the tab is bent about a hinge 51 and attached by the end 50 to the inner back cover section of the card. One metal element 56 is attached to the middle of the two slits facing down. The other metal element 55 is attached facing up to the sliding. Thus, as the card is opened and the tab slides through the slits, the two metal elements would make contact and complete an electrical circuit.

Several interesting variations of the invention also come to mind. First, paper cutout words could be superimposed on top of the El lamps to create a backlit effect on the words. Also, the EL lamps themselves could be used as a sketchpad so that a person could sign his or her name directly on the lighted lamp to create interesting effects.

FIGS. 2-5—Circuits to Drive EL Lamps

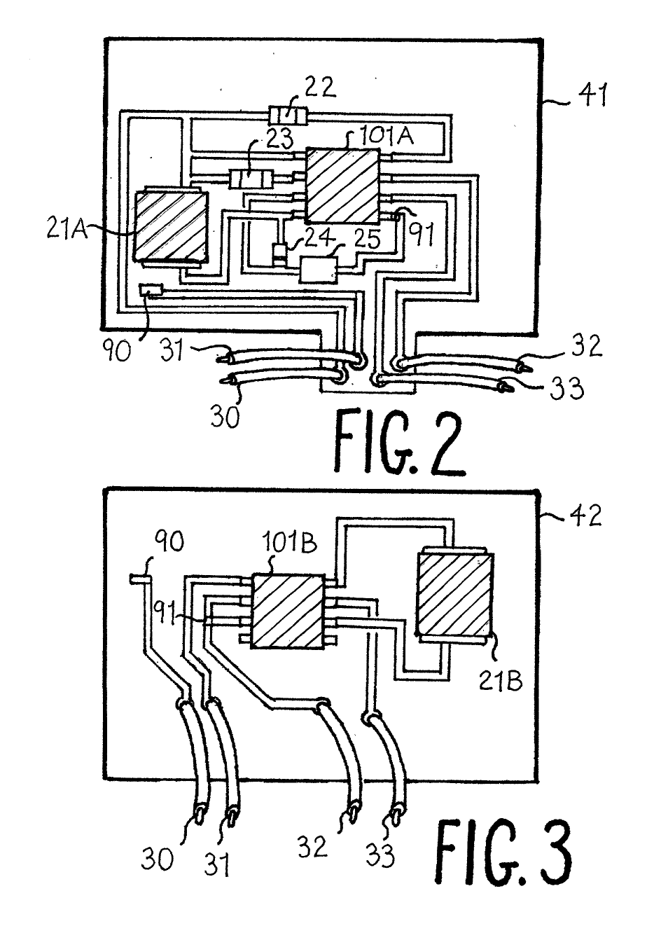

FIGS. 2 and 3 show two circuits that can drive one or more EL lamps. In order to be illuminated, an EL lamp requires a high voltage AC signal, approximately 40V to 300V peak to peak that can be generated by a number of different generic circuits. FIGS. 2 and 3 show two such possible circuits based off EL inverter or EL drivers.

FIG. 2 shows a front elevational view of a typical circuit based off Supertex's™ HV825 EL driver chip 101A suitable for driving one or more EL lamps. All the circuit elements are mounted on a flexible PCB (flex-circuit) 41. The EL driver 101A is attached to two 1 MΩ resistors 22 and 23 that are connected to a v+ trace 30. A 560 μH inductor 21A is placed between the v+ trace and the fourth pin of the EL driver. A 1N4148 high voltage diode 24 and a 10 nF high voltage capacitor 25 connect in series to the v− trace 31 to complete the circuit. On the PCB, a metal via 90 allows the trace 31 to route to the back of the PCB where it connects to a battery. Another metal via 91 routes the v− trace to the back of the PCB board to connect with the negative end of the battery.

FIG. 3 shows a front elevational view of a typical circuit based off Durel's™ D240B EL driver chip 101B. Here, the chip requires one 3.3 mH inductor 21B connected between the sixth and eighth pins of the EL driver chip. Once again, metal vias 90 and 91 allow the traces for the switch to extend to the back of the PCB 42 to connect to the battery.

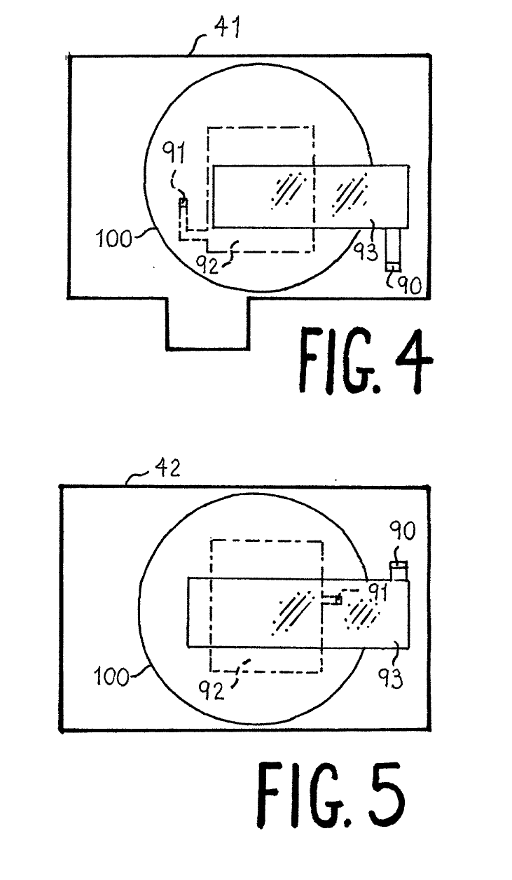

FIG. 4 shows the back elevational view of the HV825-based circuit of FIG. 2, and FIG. 5 shows the back elevational view of the D340B-based circuit of FIG. 3. A battery 100 is held clamped against the PCB by a metal clip 93. One such suitable battery is the SONY CR1220-1 lithium coin battery. The clip 93 connects to the front side of the PCB through via 90. Underneath the battery lies a metal plate or electrically conductive surface 92 which connects through via 91 to the other side of the PCB. The battery need not be directly attached to the back of the PCB. It can be attached anywhere on the PCB or greeting card as long as an electrical conductive path is established. For instance, the battery can be simply taped to the back of the inner front cover section, and the wires 30 and 31 can be routed to the location of the battery. In order to provide more voltage or current, two or more batteries could be placed in series or in parallel. Also, the electrically conductive surface 92 could be replaced by a metal spring to hold the battery more securely.

FIGS. 2 through 5 show specific application circuits used to drive the EL lamps. However, many generic EL inverters and EL driver circuits exist depending on the driver chip used and the external components selected. Although these circuits have only been described with regard to preferred embodiments, it should be understood that variations and modifications as would be obvious to one having ordinary skill in this art may be made without deviating from the scope if this invention. For instance, circuits can be configured to flash the EL lamps or sequentially turn on and off individual EL lamps.

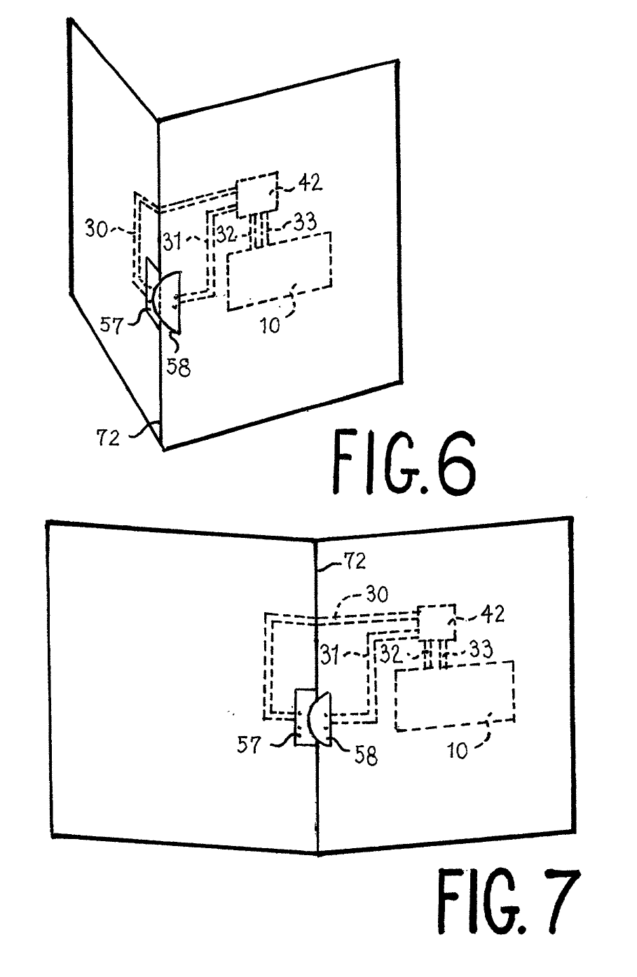

FIG. 6 and FIG. 7—Alternative Embodiments of the Illuminated Greeting Card

FIG. 6 shows an alternative embodiment of a greeting card according to the present invention. Here, instead of using a sliding switch member to close the EL driver circuitry, two contact metal elements are mounted on the spine of the card. One metal contact 57 aligns with the folded edge 72 of the card. The other metal contact 58 protrudes past the folded edge of the card. Thus, when the card is closed or partially closed, the two metal contacts do not short together and complete the circuit.

In FIG. 7, the card is in a fully opened position such that the two metal contacts 57 and 58 will overlap and complete the circuit. Once again, the PCB 42 is shown along with the two connections 32 and 33 to the EL lamp 10. The two wires 30 and 31 that are used to complete the circuit are brought out from the PCB and connected to the two metal contacts 57 and 58.

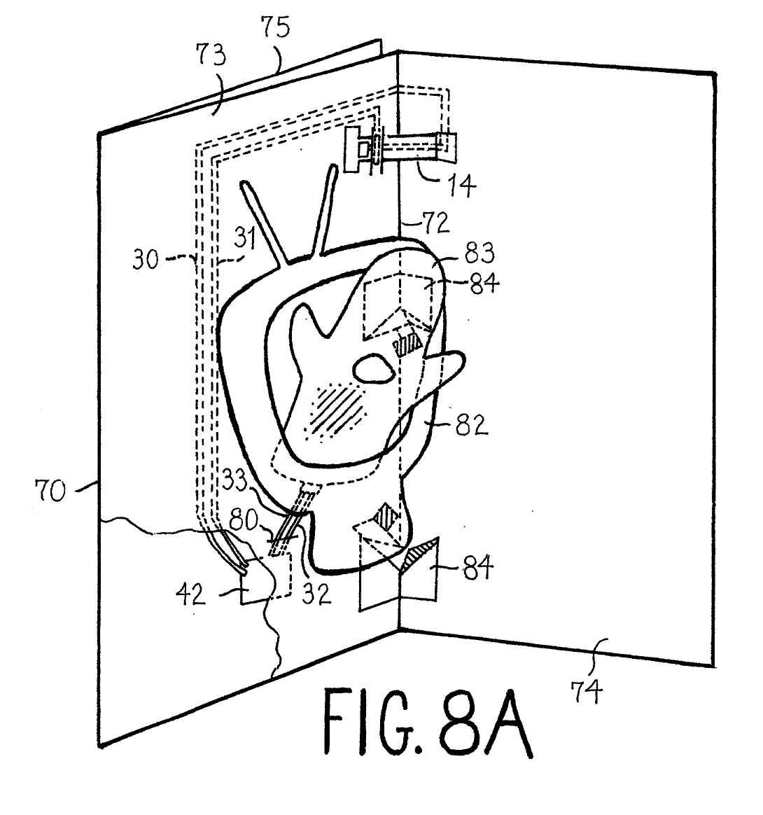

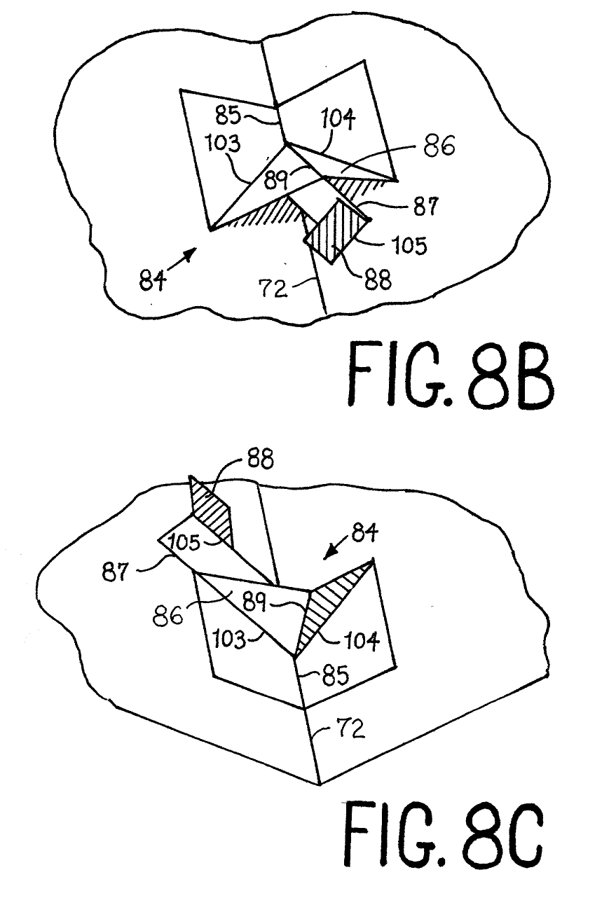

FIGS. 8A, 8B, and 8C—A Pop-Up Illuminated Greeting Card With the EL Lamp as A Pop-Up Element

FIG. 8A shows an inside perspective view of an illuminated greeting card with the EL lamp acting as a pop-up element. Once again, the EL lamp is attached to two driver outputs 33 and 32 that route out through a slit 80 in the card from a PCB circuit 42. The PCB is attached behind the inner front cover 73. Two wires and 31 route to a sliding switch 14. Here, an EL lamp cut in the shape of a ghost 83 leans forward through the opening of a television-shaped paper element 82 when the card is opened. Both the EL lamp and the television are made to pop up by use of a folded rectangular paper 84.

FIG. 8B shows in detail the folded rectangular paper that is used to prop open the ghost-shaped EL lamp while FIG. 8C shows the rectangular paper used to prop open the television cutout. This rectangular paper consists of a bottom vertical fold 85 in the same direction as the middle fold of the greeting card 72. The top half of this square paper has a triangular fold 86 with the middle fold 89 directed against the direction of the greeting card and two slanted folds 103 and 104 in the same direction as the greeting card. To one side of this triangular fold is attached a paper protrusion 87 with the end acting as an attachment area 88 bent about hinge 105 so that it is parallel with the face of the card. The pop-up EL lamp and the television-shaped element are glued to this attachment area 88. Thus, when the card closes, the triangular fold 86 and the attached pop-up elements collapse together.

Advantages

From the description above, a number of advantages of the EL-based illuminated greeting card become evident:

a) The paper-thin EL lamp can be placed anywhere on the card without adding too much thickness.

(b) In order to light a large area, only one EL lamp needs to be used rather than several point light sources.

(c) Surfaces can be uniformly illuminated.

(d) As in the case of the pop-up embodiment, the EL lamp can be easily shaped and incorporated into one of the pop-up elements.

(e) The greeting card can be made to be very flexible using a flexible EL lamp and a flexible PCB circuit to drive the lamp.

(f) With the major elements of this illuminated card being flexible, damage is less likely to occur when the card is bent, dropped or accidentally stepped upon.

(g) Senders of the greeting card can directly sign their names on the EL lamps to create interesting effects.

(h) The EL lamps can be used to backlight words and pictures.

Conclusion, Ramifications, and Scope

Accordingly, the reader will see that the EL-based greeting card can produce unique and novel illumination effects that have not been seen to date. Furthermore, because of the ultra-thin nature of EL, pop-up cards can now be readily made with illumination. Having thus described a preferred embodiment and alternative embodiments of the present invention, it is apparent that various alternatives, modifications and alterations thereto will readily occur to those familiar with the art, without departing from the spirit and scope of the invention. Accordingly, it is intended that all such obvious modifications, alterations, and improvements are part of this invention and that the invention is limited only as defined in the following claims.

I claim:

1. An illuminated card comprising:
an electroluminescent (EL) lamp for providing illumination;
a card made from paper/plastic sheet stock;
a power supply for energizing the lamp or display;
a driver circuit to convert the voltage from said power supply into a higher voltage AC signal to drive said electroluminescent lamp;
a switch closing a circuit to illuminate said electroluminescent lamp.

2. The greeting card of claim 1 wherein said switch comprises a metal element attached to a sliding tab, two slits in the card, and a stationary metal element for closing the circuit.

3. The greeting card of claim 1 wherein said switch comprises two metal elements attached to the back middle fold of the cards one said metal element aligned with the folded edge, and another said metal element protruding past the folded edge.

4. The greeting card of claim 1 further comprising multiple EL lamps to be lit simultaneously or sequentially by means of said EL driver circuit.

5. The greeting card of claim 1 wherein said EL lamp connects to said driver circuit via wires.

6. The greeting card of claim 1 wherein said power supply resides on a printed conductive material type circuit board.

7. The greeting card of claim 1 wherein said power supply resides on said sheet stock.

8. The greeting card of claim 1 wherein said EL lamp is cut into a shape appropriate for the card.

9. The greeting card of claim 1 wherein said EL lamp acts as a pop-up element.
